(19) United States
(12) Patent Application Publication
(10) Pub. No.: US 2012/0284080 A1
(43) Pub. Date: Nov. 8, 2012

(54) CUSTOMER COGNITIVE STYLE PREDICTION MODEL BASED ON MOBILE BEHAVIORAL PROFILE

(75) Inventors: Rodrigo DE OLIVEIRA, Madrid (ES); Ana ARMENTA, Madrid (ES); Pedro CONCEJERO, Madrid (ES); Cesar Martin GUERRA-SALCEDO, Madrid (ES); Alexandros KARATZOGLOU, Madrid (ES); Nuria OLIVER, Madrid (ES); Rubén LARA, Madrid (ES)

(73) Assignee: TELEFONICA S.A., Madrid (ES)

(21) Appl. No.: 13/177,615

(22) Filed: Jul. 7, 2011

Related U.S. Application Data
(60) Provisional application No. 61/482,411, filed on May 4, 2011.

(51) Int. Cl. G06Q 30/02

(52) U.S. Cl. 705/7.29

(57) ABSTRACT

It comprises computing values of cognitive and personality indicators of users of a telecom operator by means of machine learning and data mining algorithms from information available in a telecom operator system extracted from Social Network Analysis metrics, Call Detailed Record information and commercial information of said users stored in an operator's Data Warehouse and Customer Relationship Management systems as well as information from previous surveys, or questionnaires, answered by a representative sample of users as an input of said machine learning and said data mining algorithms. The method involves building a complex computer model that infers the values of the psychological dimensions of said users by means of said machine learning and said data mining algorithms to obtain a multi-dimensional vector for each of the users.

### FIELD OF THE ART

The present invention generally relates to a method for predicting user cognitive and personality profiles for every customer of a telecom operator, and more particularly to a method that uses customers' behavioral information extracted directly from the operator's records in order to compute values of cognitive and personality indicators of a multi-dimensional vector.

The method of the invention constitutes a customer cognitive style prediction model based on mobile behavioral profile.

### PRIOR STATE OF THE ART

A key asset of a telecommunications operator is the knowledge that it has about its customers. Having deep customer knowledge allows the operator to optimize the relationship with its customers, and increase customer satisfaction by means of, e.g., personalized services or attractive commercial offerings. In addition, this focus on the customers will enable the operator to maintain sustainable leadership in such a mature and competitive market.

One important piece of information about the customers is their personality and psychological profile. Until now, the knowledge that a telecommunications provider has about personality traits and its customers' psychological profile has been exclusively obtained from market research studies, usually carried out by means of surveys. Surveys typically require a huge amount of time and resources, are not easily scalable, and depend on the particular scope of the study and the context when the survey or market research is done. In addition, uncertainty and biases are introduced by well-known facts like social desirability in the responses, turning it very difficult, if not impossible, to infer values in psychological dimensions for all customers.

A telecommunications provider has a vast amount of information about its customers' communication behavior, including the customers' social networks. Therefore, there is a lot of data about “what customers do”, but there is little, if anything, about “why customers do what they do”.

Today it is commonly accepted that our observable behavior is a consequence of internal, subjective and typically non-observable psychological features. A traditional approach to study the reasons why different persons behave in very different ways, even in similar or the same context, has been through the concept of personality. Psychologists have proposed multiple personality models that include “personality traits” or dimensions. These models propose concepts—traits—that are the dynamic and organized set of a person's characteristics that uniquely influence his/her cognitions, motivations, and behaviors in a variety of situations.

An evolved concept that also includes personality is that of cognitive styles. Traditional personality psychology is based on self-reports about subjective and objective behavior, but does not include the scientific knowledge obtained in the last 20-30 years about Cognitive Psychology. For instance, decision-making, a basic human behavior, has been the focus of numerous studies, as well as many other cognitive processes. Therefore, the concept of cognitive profile is a core concept of this invention. This cognitive profile incorporates a person's personality traits together with relevant information about a user's role for recommendations, technological acceptance profile, satisfaction or complaints profiles and many other cognitive aspects.

Cognitive style is a term used in cognitive psychology to describe the way individuals think, perceive and remember information, or their preferred approach to use such information to solve problems. It is a key concept in the areas of education and management. In this invention, we use this concept in the user modeling and profiling knowledge areas.

A person's cognitive profile is stable in time, and distinguishes her/him from others. The cognitive profile dimensions are, in principle, linked to any kind of behavior. In practice, these cognitive dimensions allow researchers to study an individual's predisposition to have certain patterns of thought, and therefore engage in certain patterns of behavior.

This information is essential to understand behaviors that are key for a telecommunications operator, such as the ability to influence other people or the customers' reaction with respect to recommendations and complaints. For example, being able to automatically identify the individuals that are the most suitable for recommending a new service would yield a fast adoption; previewing complaints from users with high-expectations would allow the operator to reduce its complaints, etc. Moreover, being able to infer a multi-dimensional psychological profile vector for each customer would allow to study their behavior in the social context, what is called the customer's role within her/his social network.

From social and psychological research, it is known that these factors are key for explaining social behavior. For instance, [1] presents the results of a longitudinal study of the relationship between individuals' demographic characteristics, values, and personality and their centrality in their teams' advice, friendship, and adversarial networks. Their results suggest that highly educated, non-white, older individuals who are high in activity preference, low in neuroticism, and similar to their teammates in gender, hedonism, and tradition are most likely to gain central positions in their team's advice networks. Highly educated individuals who are high in activity preference, low in neuroticism, and low in openness to experience and who are similar to their teammates in hedonism are most likely to gain central positions in team's friendship networks. Team members who are low in education and agreeableness and high on extraversion, neuroticism, and openness to experience, and whose support for the value of upholding tradition differs from their teammates', are the most likely to become central in the adversarial network.

[2] describes how important it is for marketing practitioners to identify “social influencers” or “market mavens” in social networking sites and encourage them to spread positive product information regarding selected brands or discourage them from sharing negative information with their personal networks. Marketers must take social relationship factors into account when targeting consumers who are susceptible to interpersonal influence, as they are more likely to follow social influences.

[3] found that the likelihood that consumers complain over defects and deficiencies depends a lot on the situation, related to the size of the perceived loss. This study shows that complaining depends on the person's attitude towards complaining and on personality traits (negative affectivity).

Other authors have already studied the influence of personality in the way people connect through online social networks. For instance, [9] examines the effect of individual psychological differences on network structures. Results suggest that people who see themselves as vulnerable to external forces tend to inhabit closed networks of weak connections. People who seek to keep their strong tie partners apart, and thereby bridge structural holes, tend to be individualists, to believe that they control the events in their lives, and to have higher levels of neuroticism. Finally, people with strong network closure and “weak” structural holes (as with the “strength of weak ties”) tend to categorize themselves and others in terms of group memberships. They also tend to be more extraverted and less individualistic.

A related piece of work [8] examined individual differences in people's propensity to connect with others (PCO). PCO and its components were significantly positively associated with social network characteristics (including size, between-ness centrality, and brokerage) and indicators of personal adjustment including support received, attainment, well-being, influence, and suggestion-making. PCO had effects beyond those of major personality traits, and PCO components displayed distinctive relationships with work network characteristics.

Finally [6] investigates consumers' intentions to use innovative mobile services from a social network perspective. Results show that both personal (i.e., opinion leadership and experience with the communication mode) and similarity attributes of social network members have a significant impact on network position, that is, their level of individual connectedness and integration.

In the field of Human-Computer Interaction (HCI), the importance of identifying the users' personality traits and preferences in order to build adaptive and personalized systems with an improved user experience has been largely emphasized.

[21] conducted a study with 72 students in which each participant accessed an e-commerce website and listened to five book descriptions via either an extrovert or an introvert synthetic voice. Their findings revealed a significant crossover interaction between computer voice personality and subject personality for social presence, thus indicating that respondents felt stronger social presence when they heard a computer voice manifesting a personality similar to their own.

[22] created a model of agent emotion elicitation for various types of interfaces. They conducted a user study with 40 subjects and found six human emotions to be strongly correlated with the intensity of the personality traits (e.g. the more neurotic one is, the less joy he/she has in a given scenario). They leveraged these correlations to improve the model of non-playable characters in 3D games. Similarly, [23] enhanced the user experience with robots by implementing versions with different personality traits.

More recently, [37] have proposed a mobile phone application to encourage long term adoption of physically active behaviors by: (1) recommending a list of games compatible with the user's personality traits; and (2) including a motivational agent whose spoken phrases are also chosen based on the user's traits.

The knowledge of people's psychological profile is a key asset for designers to build personalized computing solutions with better user experience. Moreover, it is a strategic advantage to a telecommunications company given that it strongly influences the structural role in a social network, particularly in a mobile social network, which consequently affects the adoption or spread of new technologies or services over the mobile social networks.

However, even though personality profiles have shown to be useful in a range of application domains, the automatic assessment of the users' personality traits and sub-traits (facets) is still a challenge. This task is usually achieved by either explicit or implicit methods. Explicit methods require the deployment of long surveys with up to 350 questions. In addition to the overhead of answering a few hundred questions before using an application, users may also feel uncomfortable with personality related surveys. Implicit methods aim at inferring personality from observed behavior. However, current implementations of the implicit approach usually require monitoring sensitive output channels, such as keyboard usage—from which passwords could be recorded—and snippets of daily conversations—that could be used to reveal private and highly personal information.

Among the recent inventions that are somehow related to the cognitive analysis of the users/customers, the meaning of the “cognitive information”, as for example the information that reflects the user's personality, varies in a quite wide range.

In [10], the personality models are based on the user's musical preferences and the system includes a matching comparison technique which matches users based on the similarity of their respective musical preferences. As it is explained within the invention description, there are acknowledged statistical correlations between areas of musical preference and personality attributes.

Similarly, but taking into account the preferences for other items, [14] proposes an Internet-audiotext electronic advertising system with psychographic profiling and matching. When a person places a personal ad on the system, either via a telephone or via the Internet, the person creates a personal psychographic profile (a subjective makeup of preferences) of himself by selecting his preference for various items, such as musical pieces, environmental sounds, poetry selections, etc. At the end of the profiling process, the system automatically finds other advertisers whose profiles match the new advertiser's profile.

In [17], a portable communication device and method for sharing a user personality is presented, where the user personality profile is based on user activities and preferences involving the portable communication device, and could be shared to third parties.

Other proposals focus on emotional or gestural information, such as [12] where the customer personality and mood characteristics is assessed to enhance customer satisfaction and improve the chances of a sale. The personality and mood characteristics are obtained by analyzing various features of the customer—such his/her facial image, gait and location of his/her gaze—combined with other personalized information—such as who the customer is shopping with and information contained in the customer's profile (when it exists). [15]'s “Emotion data supplying apparatus, psychology analyzer, and method for psychological analysis of telephone user” estimates the user's health, emotion, intelligence, psychological state, desire, and human relation from emotional input data.

[11] “Real-time network personality analysis method and system” works with esoteric information: a personality analysis module can provide the user's possible personalities using a horoscope according to his/her birthday, and can also predict his/her fortune according to name and even mental analysis. It operates when a first user and a second user are simultaneously connected through a network, and provides real-time personality analysis results of the second user to the first user.

There are solutions that build their personality models based on input gathered from multiple sources, such as [13]: A system and method for behavioral psychology and personality profiling to adapt customer service communications, where the design of the profiles includes collecting information from an on-line survey, on-line habits, a game, card transactions, a telephone survey, a letter, or an in-person interview. One or more behavioral profiles may be updated based on additional information gathered from or about the customer.

There have been several proposals about systems that allow the users to directly customize the description of their personality profiles. For instance, [18] presents a system that allows users to express their own personality to other people and meet them based on compatibility/incompatibility/partial compatibility of personality. The system apparatus enables a user to show his/her own personality to the general public through a network, displays a degree of match-mismatch of personality with other users and enables users desiring communication to communicate with each other. Similarly, [19] describes a social network for affecting personal behavior where user-customized profiles are used to elucidate user traits. The social network provides the registered user with other users who can track his/her progress and support by communicating with him/her. And the user can change his/her psychological state by moving a scroll bar through a list of predefined emotional states.

There are methods focused on consumption profiles from a commercial point of view: [16] proposes a method and system to utilize a psychographic questionnaire in a buyer-driven commerce system. The psychographic questionnaire is specifically designed to assess the buyer's needs and purchasing patterns. The results of the gathered information are used to determine actions that may be applied to the offer. In addition, [20] describes a system and method for matching consumers with products, where the cognitive information includes consumer, product and/or vendor profiles including a weighted personality aspect set. The cognitive information also includes consumer interests, and parameters linked to consumer fact information.

In the field of Human-Computer Interaction, scholars have tackled the automatic personality assessment problem by inferring personality traits from logged human behavior.

For instance, [24] recorded the users' interaction with keyboard and mouse, and verified that some traits and sub-traits (facets) are strongly correlated with a number of actions and the speed between the actions. Likewise, [25] found strong correlations between personality traits and specific keystrokes, mouse events, and standard deviation time between events.

Other approaches to infer personality are based on human speech. [26] found that audio recorded from daily conversations can help predict personality traits. However, identifying alternative approaches to infer the users' personality without revealing private and sensitive information (e.g., private conversations, passwords, etc.) is of extreme relevance for the design of novel personalized interactive systems.

Problems with Existing Solutions

All the above mentioned existing solutions are based on interactive mechanisms to obtain the input for their processes and algorithms, i.e. they require explicit input from users or customers to obtain the psychological or cognitive factors, either by asking the user to introduce personal information as in [14] [18] [19], or by means of a general purpose questionnaire that requires the answers, as in [16], or specific input from the user as i.e., music preferences [10]. Conversely, the solutions provided in the field of Human-Computer Interaction apply implicit methods for personality assessment and hence they do not require any explicit interaction with the users. Instead, these solutions require monitoring sensitive output channels, such as keyboard usage [24] [25] and snippets of daily conversations [26]. However, these approaches could be used to reveal private and highly personal information.

There is another limitation of previous art, directly linked to their interactivity: scalability. All the above mentioned related work would be extremely costly to deploy for large user populations, such as the customer base in a telecom operator. Only by means of automatic mechanisms we can obtain a rich profile for millions of users.

The characterization of influence among users, despite being a recent field of study, has a high number of publications related to, mainly, online social networks. [4] and [5] analyze the graphs created from online social networks users, such as Flickr (www.flickr.com) or Myspace (www.myspace.com) and carry out tests to infer properties about their structure and evolution. They also suggest to split the global social network in small graphs or communities, created by users with a strengthen relation and who are influenced by individual and social issues, for instance the number of close people who already belong to that community.

Additionally, many of previous proposals are limited in their scope, e.g. only focused on music and personality [10], or on sharing personality information with other people.

In summary, there is currently no generic solution to automatically infer the psychological profile of telecom operators' customers from existing logged data. None of the existing solutions work on mobile network behavioral records to infer the customer's cognitive profile.

### DESCRIPTION OF THE INVENTION

It is necessary to offer an alternative to the state of the art which covers the gaps found therein, particularly related to the lack of proposals which really allow creating a multidimensional cognitive and personality profile vector for every costumer of a telecom operator from costumer behavior data without deploying market research surveys or monitoring the interactions with the customer.

To that end, the present invention provides a method for predicting user cognitive and personality profiles, comprising computing values of cognitive and personality indicators of a multi-dimensional vector regarding at least one user of a telecom operator by means of machine learning and data mining algorithms receiving inputs from at least information available in the telecom operator systems.

Other embodiments of the method of the first aspect of the invention are described according to appended claims 2 to 8, and in a subsequent section related to the detailed description of several embodiments.

### BRIEF DESCRIPTION OF THE DRAWINGS

The previous and other advantages and features will be more fully understood from the following detailed description of embodiments, with reference to the attached drawings, which must be considered in an illustrative and non-limiting manner, in which:

FIG. 1 shows the main components of the proposed invention in this document.

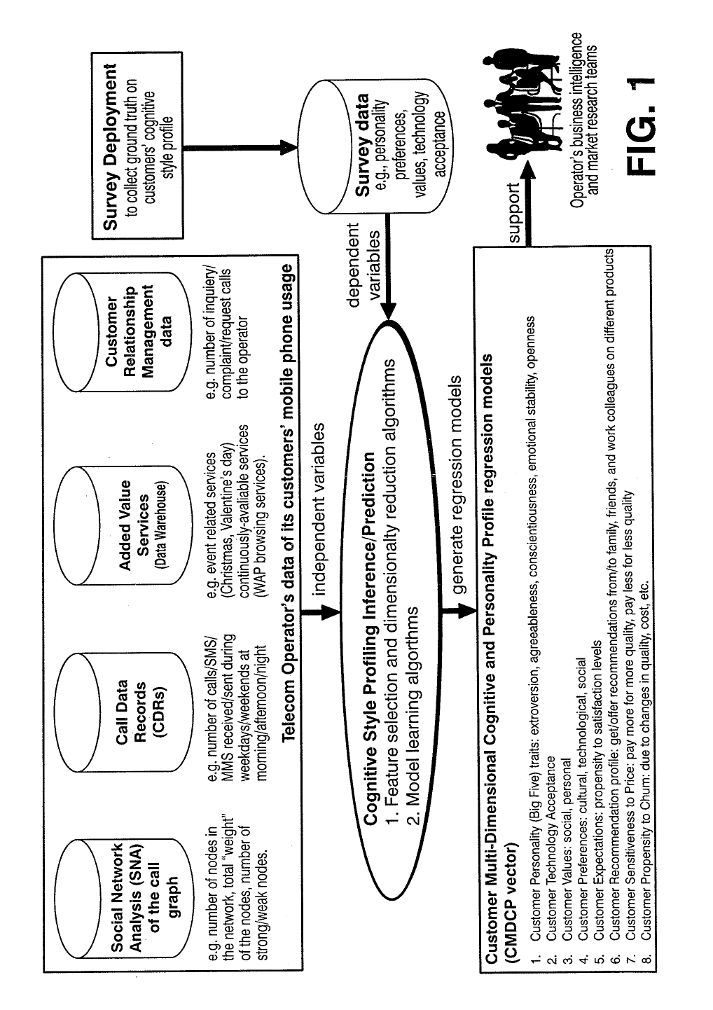

FIG. 2 shows an example of an application of the proposed invention in this document.

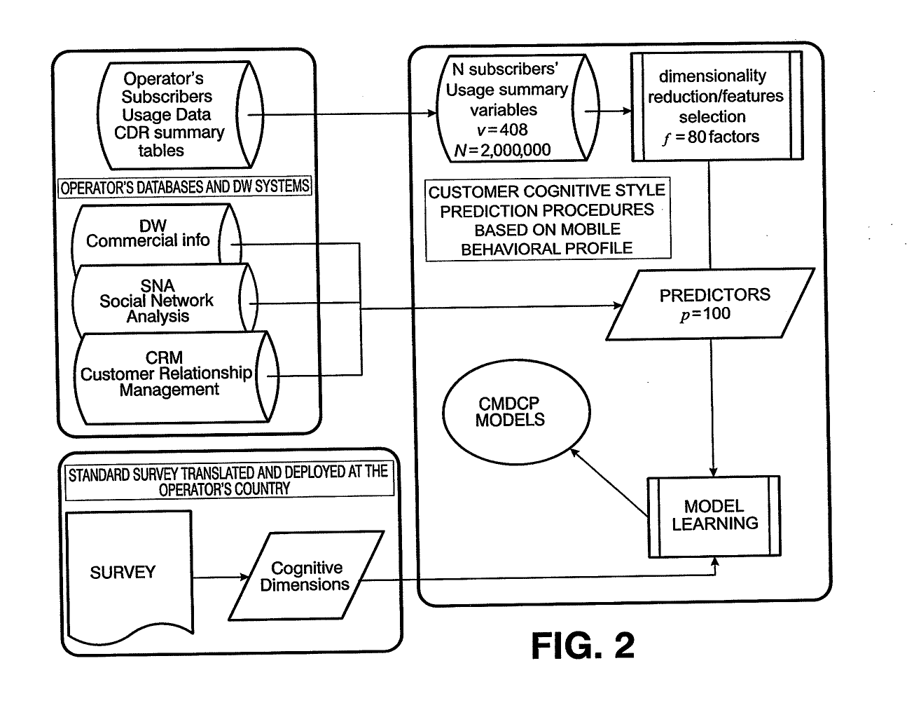

FIG. 3 shows the potential uses of computed CMDCP (Customer Multi-Dimensional Cognitive and Personality) profiles in business settings according to the invention proposed in this document.

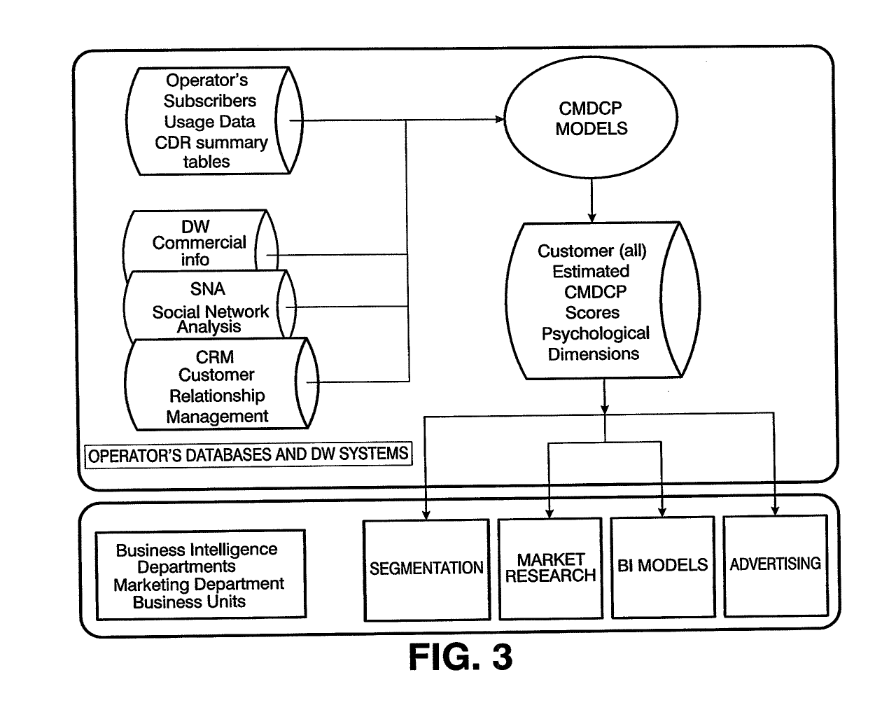

FIG. 4 shows an example of predictive model for the costumer's propensity to complain according to an embodiment of the invention proposed in this document.

### DETAILED DESCRIPTION OF SEVERAL EMBODIMENTS

The invention described herein automatically computes an inferred Customer Multi-Dimensional Cognitive and Personality profile, as a vector of estimates in several dimensions for every customer of a telecom operator, representing her or his cognitive style and personality. The method uses the customers' behavioral information extracted directly from the operator's records, without asking the customers for any profile definitions or customizations. It is based on Social Network Analysis (SNA) metrics, Call Detailed Record (CDR) information, and customers' commercial information, as stored in the operator's Data Warehouse (DW) and Customer Relationship Management (CRM) systems.

The invention comprises a two-step methodology: (1) Data Collection: In a first step, a specific survey developed exclusively for the purposes of the procedure is deployed in a region (e.g. country) where the system is to be installed. Responses from a representative sample of actual customers, who are required to be the operator's active customers for a certain period of time, are used in a second step to train and calibrate the models; (2) Model Learning: Customer cognitive style models are learned from the collected data and embedded in a system that is installed in the operator's Business Intelligence and Marketing systems, in order to obtain the cognitive styles for all the operator's customers. These cognitive styles, personality dimensions and related scores can be then used for a range of business purposes in the traditional business.

The main objective of the invention is to serve as an additional input of the marketing models that are developed across the business units of the operator. By adding the customer's predicted cognitive style to commercial information and/or network role information, the operator increases its customer insights and hence creates a strategic advantage over competitors.

The invention described herein is the first to propose automatic mechanisms to infer the psychological and cognitive profiles from communication records, without analyzing any content of the actual communication between the users. This is an important aspect of the proposed system, since either the direct mechanisms as explained before, or the indirect methods, as for example asking for preferences or answering a survey, require explicit consent from the user, and special security mechanisms to store the obtained data. This invention is based on Call Detail Records (CDR), an automatic registry that is stored every time that a telecommunications user sends or receives a call.

This invention adds a completely new dimension to current systems that analyze automatic records. With these systems it is possible to obtain the communities formed by users talking to each other in a regular fashion, as well as node metrics, like number of members in communities, weight, etc. However, these measures say little about the user's psychological features, and in particular, say nothing about the reasons why and how the communication happens. Hence, this invention adds knowledge about the individual psychological and cognitive features, while using the same well-established mechanisms of Social Network Analysis.

This proposal is centred upon a customer multi-dimensional cognitive and personality (CMDCP) profile, which is automatically obtained by means of machine learning and data mining algorithms that compute all values in CMDCP from information available in the telecom operator systems: SNA and communities, Call Detail Records (CDRs), Data Warehouse (DW) and Customer Relationship Management (CRM).

The core of the invention is the psychographics profile inference algorithms and the CMDCP vector. The operator would make use of this vector in a variety of applications, including marketing campaigns. For instance, when preparing a marketing campaign of new advanced services, the operator may want to target its customers with the highest technology acceptance levels, which is one of the outputs of the cognitive profiling predictive modeling. Since there is a variable level or uncertainty associated to the different marketing needs, and at the same time to the components of the CMDCP, the invention incorporates variable confidence levels and thresholds to optimize the selection of candidates or for the preparation of lists.

It will be described next the methodology and procedure followed to compute the CMDCP scores. The procedure is a 4 step process:

1. The first step in the methodology requires deploying a survey where a sample of the operator's subscribers that have been active customers for a certain period of time called the study period (e.g. 6 months, 1 year, etc . . . ) fill a standard questionnaire.

2. The questionnaire responses from the customers, together with the operator's customer data (e.g. Call Detail Records, communication Social Network, etc . . . ) are used for training machine learning and data mining algorithms to build a computer complex model that infers the values of the customers' psychological dimensions, as defined by the CMDCP vector, from the operator's customer data.

3. This model is then implemented and run to obtain the CMDCP vector for all the operator's customers.

4. The scores contained in the vector are used for business intelligence and marketing tasks within the operator.

Survey Deployment

In order to have training data for computing the cognitive models, a survey shall be carried out to obtain actual data from a subset of the operator's customers.

For this purpose, a questionnaire is designed, which contains questions and rating scales for obtaining the following actual dimensions i.e., non-estimated, but directly answered by customers:
IPIP-50 a personality questionnaire which allows the direct estimate of the following personality traits [35]: agreeableness, consciousness, extraversion, neuroticism and openness.
Acceptance of the technology: technology for personal use, technology as used by your environment.
Values: social values (attitudes towards family, friendship, work), individual values (body care, culture, sports).
Preferences: cultural preferences (go to cinema or theater, reading), social preferences (towards social relationships), technological preferences (usage of video-games, internet)
Expectations about telecommunications services: perceived quality and operator's brand image, propensity to express complaints.

In an embodiment of his invention, additional personality dimensions—that are of interest for the operator's business intelligence—could be obtained from the data in the IPIP questionnaire: extraversion and social desirability, emotional sensitiveness, personal organization, kindness, misunderstandings or troublesome IPIP items with no particular explanation

Customer Behavioral Data Extraction

The operator's available customer usage data are extracted to be used as input of the models. These data include, but are not limited to:

1. Call Detail Records (CDRs): hundreds of variables (408 in an implementation of this invention) that summarize every customer's mobile phone usage are computed from the CDR available in the operator's data warehouse. Definition of the summary usage variables (time ranges—ranges of hours for computing summaries of voice calls, SMS and MMS usage) as well as ratios are property of the operator.

2. Social Network Analysis variables are also stored in the operator's data warehouse, including, but not limited to the following customer's SNA individual metrics below. Unless stated otherwise, all are SNA standard metrics [36].
Degree: Total number of contacts of a particular customer.
Weighted degree: Sum of weights of all customer contacts
Degree strong contacts: Number of strong contacts of a particular customer
Two-step reach: Number of nodes connected in two steps with strong contacts.
Reach efficiency: Reach divided by number of strong contacts of a particular customer.
Clustering coefficient: Density of neighbors sub-graph.
Clustering coefficient strong contacts: Density of neighbors with strong contacts sub graph.
Number of Communities: Total number of communities where the customer is present
Weighted Out degree: Sum of the weights of outbound communications of the customer.
Weighted In degree: Sum of the weights of incoming communications of the customer.

3. Additional variables that are available in the operator's data warehouse and commercial information databases shall be transformed and operationalized to be used as inputs of the predictive models. A usual way of introducing qualitative variables into the models is by means of dummy variables. Let's call the number of these variables d. An example is given below:

TYPE OF TERMINAL—this is available in the operator's commercial databases. An example of operationalization is the following:
if TERMINAL_=“BASIC” then DUM_TERM_BASIC=1; ELSE DUM_TERM_BASIC=0;
if TERMINAL=“PHOTOGRAPHY” THEN dum_term_multim=1; else dum_term_multim=0;
if TERMINAL=“SMARTPHONE” then dum_term_smart=1; else dum_term_smart=0;

Feature Selection and Dimensionality Reduction

The number of variables available in the operator's databases is typically large (˜500). However, not all of the variables are usually relevant in modeling. Adding variables to a model that have no utility in the modeling process is akin to adding a source of noise to the modeling process. Therefore, feature selection methods are used to select a set of variables that maximize the performance of the model.

Standard Machine Learning methods for variable selection include Minimum-redundancy-maximum-relevance (Min-Max), where variables with the highest correlation to the target variable are selected; recursive feature elimination (RFE) [30], where variables are ranked according to the impact they have on the objective function of a Support Vector Machine. The variables with the lowest impact are then recursively eliminated; sparse Regression-based methods like e.g. LASSO [31], where an L1 regularizer imposes scarcity in the regression model thus shrinking the entries in the regression parameter vector to 0 for variables that are not relevant for the model. In this case, the feature selection process and the model creation/optimization process happen simultaneously; and Principal Component Analysis (PCA), kernel PCA and Factor Analysis.

Model Learning

Once the relevant features have been selected, standard Regression methods such as least squares regression can be used to model the target psychometric variables. More advanced methods such as Ridge Regression and LASSO offer the advantage of regularization which ensures better generalization behavior.

Support Vector Machines for regression offer both regularization and non-linearity by the use of an appropriate kernel such as a Gaussian radial Basis function kernel. Nonlinearity can be important since it ensures that non-linear effects between the predictor variables and the target variables can be appropriately captured.

Once the models have been learned and the CMDCP vector has been created, CMDCP scores can be used, in isolation or jointly with usage or any other available information, to build predictive models for business-related targets, such as complaint behavior and the consumption of added-value services.

It will be described next an exemplary implementation of this invention's methodology, as developed and tested in the period 4th quarter 2010 and 1st quarter 2011 in Mexico. Other implementations of the proposed methodology are obviously possible.

For the following definitions and formulae:
N is the number of subscribers in a random sample of the operator's subscriber base
n is the number of subscribers from an operator who have participated in a Cognitive Styles survey
v is the number of mobile telephony usage variables stored in an operator Data Warehouse (e.g. Call Detail Records, etc . . . )
f is the number of features or dimensions selected from v
p is the number of predictors as used in CCSP models (equal or greater than f)
d is the number of additional or dummy variables
m is the number of dimensions of the CMDCP vector

The particular implementation that exemplifies and provides validation of the procedures contained in this patent can be summarized in four steps, as follows:

1. Survey Deployment

The standard survey (questionnaire) as described above was deployed in Mexico (Telefónica Mexico=TEMM) from October 2010 to January 2011, obtaining a total of n=713 valid questionnaires.

2. Customer Behavioral Data Extraction

All available variables in TEMM DW systems were extracted: (1) A total of 408 summary variables were computed from the CDRs available in the operator's data warehouse; (2) SNA variables and (3) commercial information from DW and CRM were also extracted from TEMM systems and stored in a table in the operator's systems.

Additional variables that are available in the operator's data warehouse and commercial information databases shall be transformed and operationalized to be used as inputs of the predictive models. A usual way of introducing qualitative variables into the models is by means of dummy variables.

3. Feature Selection and Dimensionality Reduction (Factor Analysis)

It is important that the usage data is representative not only the subscribers contacted on the survey but more importantly of the entire subscriber population. Therefore, a 10% sample (simple random sample) of the operator's subscriber base was extracted (N) and the surveyed subscribers were attached to it. In this case, N=2 000 000 (two million) subscribers randomly selected from TEMM database.

This sample is stored in a table in the first developed system to compute the following steps, containing the following variables from CDR databases (a total of v=408).

Factor Analysis was chosen as the dimensionality reduction procedure. Factor Analysis is a well-known dimensionality reduction technique: from v initial usage measurement variables, we compute scores for f scores which capture as much variability of the original variables as possible. Factor analysis has the additional benefit of allowing rotations, i.e., optimization of the f dimensions obtained, so that they have some properties. Very often it is interesting to have uncorrelated predictors, and this is possible using an orthogonal rotation.

Z_{NV}=F_{Nf}P′_{fv}

Where Z_{NV} is the standard score data matrix of N individuals and v variables

F_{Nf} is the standardized factor score matrix for the same N individuals but with f factors, and

P′_{fv} is the factor by variable weight matrix, or the rotated factor pattern (after rotation)

There are several algorithms for computing P′_{fv}, usually called factor extraction methods. Maximum Likelihood (ML) was chosen as the extraction method [32]. After the initial extraction, a Varimax rotation [33] is performed. This is an orthogonal rotation, it produces uncorrelated vectors (dimensions included in F_{Nf} have zero correlation).

P′_{fv} is finally implemented as the Rotated Factor Pattern obtained as output of SAS PROC FACTOR procedure [32]. P′_{fv} contains a large part of our predictors in the CCSP models, but some more predictors, all of them available in the operator's Data Warehouse (DW) can be added.

It is well known that factor analysis procedures (introduced above in the process) require the specification of the number of factors to be extracted, and they do not provide any clue of an optimal number of factors. Since the factor solution is totally dependent on the requested number of factors, a parallel analysis [27] was run with the R library nFactors [29].

At the end of this process, f=80 factors were chosen such that they capture the largest part of the variance between predictors.

4. Model Learning

For each of the dimensions in the dataset, a linear regression model is computed. Therefore we have m=19 linear regression models of the form:

Ŷₘₙ=Xₚₘβₘ

The procedure chosen for computing the linear regression is the FORWARD iterative variable selection procedure (SELECTION=FORWARD in SAS PROC REG).

Therefore, 19 βₘ vectors are obtained, which contain the weights in the linear combinations which allow to reproduce the actual dimensions from the p (with p=100) predictors.

These vectors can be used then for any other subscriber of the operator, thus allowing to compute the CMDCP dimensions for any number of subscribers, and which can be stored in the operator's databases. This is productized in the following step.

Once the models have been learned and the CMDCP vector has been created, CMDCP scores can be used, in isolation or jointly with usage or any other available information, to build predictive models for business-related targets, such as complaints behavior and the consumption of added-value services.

Use Case

CMDCP scores can be stored in the same operator's database and data warehouse systems as the rest of the data, and can be used, in isolation or jointly with usage or any other available information, for a variety of purposes within the operator's Business Intelligence (BI) and Marketing departments. For instance, they can be the input of BI predictive models, used for segmentation purposes, or to select the appropriate target group in a particular advertising campaign.

The use case scenario consists of the proposed system installed at the company's market research and business intelligence departments, which is used to automatically infer the psychometric profiles of its customers without having to deploy long and expensive studies. This psychometric information could then be used to reduce churn, improve recommendations to customers, increase their satisfaction with the services provided, etc.

As exemplary embodiments of the invention herein described, we present the system used to predict the propensity to complain, the consumption of added value services, and the recommendation behavior.

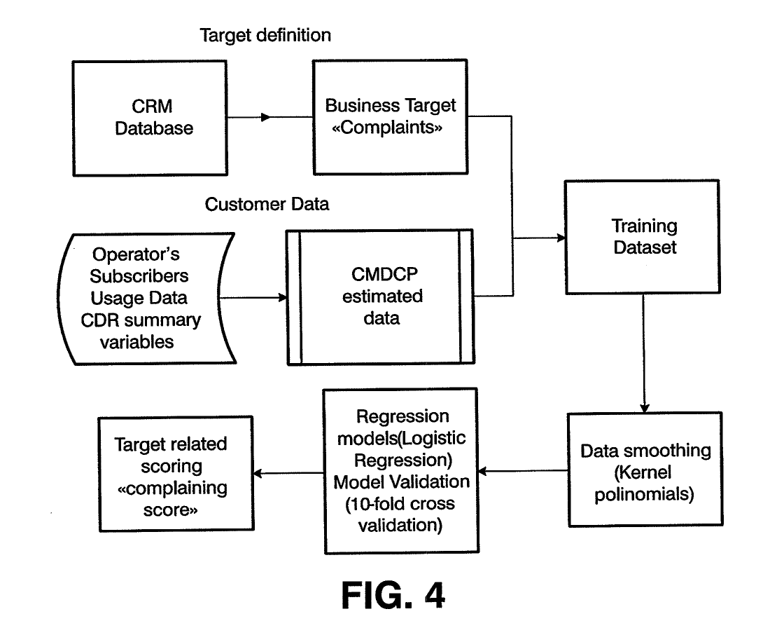

It was shown in FIG. 4 an example of the process followed to predict the customer's “propensity to complain” by means of a “complaint likelihood score”. The target definition: Which of the customers in the sample have complained? In an embodiment of this invention every customer that complained at least once in the period of study is considered.

Additional applications of the invention presented herein include, but are not limited to:

The method allows for identifying user groups with similar profiles that, combined with other socio-demographic traits, would allow the telecommunications operator to focus on the optimal targets for marketing campaigns of new products and services.

The multidimensional cognitive information vector could help in the identification of customer segments based on their technology acceptance profile.

The telecommunications operator could develop new contextual applications and services that might be customized according to the cognitive style of the customer.

New e-health applications could take into account the cognitive styles distribution across the mobile social network and try to find those customers (family or friends) linked to a given subject, who could better help in the treatment.

Advertisement provisioning could be done adapted to the customers' specific cognitive characteristics.

A company could adapt the means of communication with their customers by trying to enhance the satisfaction levels. Customer satisfaction is closely related to the kind of the expectation or trust one has on a specific brand. Hence, the proposed method could help to identify the subjects with the highest or lowest scores of expectancy level due to their mobile usage patterns.

Finally, the knowledge of the customers' cognitive styles distribution that can be achieved with this invention would support the design of a number of innovative, human-centric services and applications.

### ADVANTAGES OF THE INVENTION

This invention provides a completely automatic way to create a multidimensional cognitive and personality profile vector for every customer of a telecommunications operator from customer behavior data. This means that neither the deployment of market research surveys nor direct interactions with the customer are necessary in order to obtain a descriptive picture of our customers. The input variables to the models are based upon communication patterns and commercial information available to the operator. Note, however, that the contents of these communication instances are not considered. Hence, the method respectfully preserves the customers' privacy, as it is mainly based on communicative behavioral patterns.

The psychological profile generated, i.e., the psychological scores of the model, provide the following benefits to the operator's business intelligence and marketing units:

1. Having the personality profile alone is already useful for these units, as it can be used for segmenting the customer base.

2. From a practical perspective, the customer's personality profile is automatically computed and could be used as an input to estimate business variables, either alone or in combination with other available variables.

3. Even though personality profiles are culture-dependent, the proposed methodology should be universal to all cultures.

A person skilled in the art could introduce changes and modifications in the embodiments described without departing from the scope of the invention as it is defined in the attached claims.

### ACRONYMS

SN Social Network

SNA Social Network Analysis

PCO Propensity to Connect with Others

CMDCP Customer Multi-Dimensional Cognitive and Personality Profile

CDR Call Detail Record

CCI Customer Commercial Information

### REFERENCES

[1] Katherine J. Klein, Beng-Chong Lim , J. L., Saltz and D. M. Mayer. How Do They Get There? An Examination of the Antecedents of Centrality in Team Networks. Academy of Management Journal, 2004. Vol. Vol. 47, No. 6, pp. 952-963
[2] Chu, S.-C. Determinants of Consumer Engagement in Electronic Word of-Mouth in Social Networking Sites. Ph. D. Dissertation. The University of Texas at Austin, 2009.
[3] John Thøgersen, Hans Jørn Juhla, C.S.P Complaining: A Function of Attitude, Personality, and Situation. American Marketing Association Marketing and Public Policy Conference, 2003.
[4] R. Kumar, J. Novak and A. Tomkins. Structure and evolution of online social networks. In Proceedings of the 12th ACM SIGKDD international conference on Knowledge discovery and data mining, Philadelphia (USA), 2006. Pages 611-617.
[5] L. Backstrom, D. Huttenlocher, J. Kleinberg and X. Lan. Group formation in large social networks: membership, growth and evolution. In Proceedings of the 12th ACM SIGKDD international conference on Knowledge discovery and data mining, Philadelphia (USA), 2006. Pages 44-54.
[6] Mirella Kleijnen, Annouk Lievens, K. d.R. & Wetzels, M. Knowledge Creation Through Mobile Social Networks and Its Impact on Intentions to Use Innovative Mobile Services. Journal of Service Research, 2009, pp. 12-15
[7] Pedersen, E. Adoption of Mobile Internet Services: An Exploratory Study of Mobile Commerce Early Adopters. Journal of Organizational Computing and Electronic Commerce. Volume 15, Issue 3, 2005, Pages 203-222
[8] Peter Totterdell, David Holman, A. H. Social networkers: Measuring and examining individual differences in propensity to connect with others. Social Networks, 2008, Vol. 30, pp. 283-296.
[9] Yuval Kalish, G. R. Psychological predispositions and network structure: The relationship between individual predispositions, structural holes and network closure. Social Networks, 2006, Vol. 28, pp. 56-84.
[10] System and method for creating and using personality models for user interactions in a social network. Zilca Ran, Eschmann Caitlin US2010030772(A1)—2010 Feb. 4.
[11] Real-time network personality analysis method and system. Chen Chin-Min[TW] EP1164517(A1)—2001 Dec. 19.
[12] Assessing personality and mood characteristics of a customer to enhance customer satisfaction and improve chance of a sale. Grigsby Travis, M. Mishra Gsunil Kumar US2009299814(A1)—2009 Dec. 3.
[13] System and method for behavioural psychology and personality profiling to adapt customer service communications. Armstrong Michael, Budde Shawn US2008201199(A1)—2008 Aug. 21.
[14] Internet-audiotext electronic advertising system with psychographic profiling and matching. Speicher Gregory J. US2005083906(A1)—2005 Apr. 21.
[15] Emotion data supplying apparatus, psychology analyzer, and method for psychological analysis of telephone user Ishizaki Kiyoshi JP2006061632 (A).
[16] Method and system for utilizing a psychographic questionnaire in a buyer-driven commerce system. Walker Jay S., Tedesco Daniel E., Jorasch James A. WO0034843 (A2).
[17] Portable communication device and method for sharing a user personality. Dunko Gregory A, Kurt Schmidt. CN101682645 (A).
[18] System for providing chance of expressing user's own personality to other person and chance of meeting based on compatibility/incompatibility/partial compatibility of personality. Mori Masaoki JP2009093523 (A).
[19] Social network for affecting personal behaviour. Stephen J. Brown. 7720855.
[20] System and consumers with products. Sylvia Tidwell Scheuring, Jerome James Scheuring, David A. Schultz , US705010000.
[21] K. M. Lee and C. Nass. Designing social presence of social factors in human computer interaction. In CHI '03: Proc. of the SIGCHI conf. on Human factors in computing systems, pages 289-296, New York, N.Y., USA, 2003. ACM.
[22] M. Eckschlager, R. Bernhaupt, and M. Tscheligi. Nemesys: neural emotion eliciting system. In CHI '05 ext. abstracts on Human factors in computing systems, pages 1347-1350, New York, N.Y., USA, 2005. ACM.
[23] J. Goetz and S. Kiesler. Cooperation with a robotic assistant. In CHI '02: extended abstracts, pages 578-579, New York, N.Y., USA, 2002. ACM.
[24] B. Saati, M. Salem, and W.-P. Brinkman. Towards customized user interface skins: investigating user personality and skin colour. HCI 2005—PROCEEDINGS vol. 2, 89-93,2005.
[25] I. A. Khan, W.-P. Brinkman, N. Fine, and R. M. Hierons. Measuring personality from keyboard and mouse use. In ECCE '08: Proc. of the 15th European conf. on Cognitive ergonomics, 1-8, New York, USA, 2008. ACM.
[26] F. Mairesse and M. Walker. Automatic recognition of personality in conversation. In NAACL '06: Proceedings of the Human Language Technology Conference of the NAACL, Companion Volume: Short Papers, pages 85-88, Morristown, N.J., USA, 2006. Assoc. for Comp. Linguistics.
[27] Horn, J. L. (1965). A rationale and test for the number of factors in factor analysis. Psychometrika, 30, 179-185.
[28] O'Connor, B. P. (2000). SPSS and SAS programs for determining the number of components using parallel analysis and Velicer's MAP test. Behavior Research Methods, Instruments & Computers, 32(3), 396-402.
[29] Raiche, G. and Magis, D. (2010). Package ‘nFactors’. Parallel Analysis and Non Graphical Solutions to the Cattell Scree Test. Available at CRAN repository: http://cran.r-project.org/web/packages/n Factors/n Factors.pdf.
[30] Guyon I, Weston J. Barnhill S. Vapnik V. (2002). Gene Selection for Cancer Classification using Support Vector Machines Gene Selection for Cancer Classification using Support Vector Machines, Machine Learning volume 46, issues 1-3.
[31] Tibshirani R (1996). “Regression shrinkage and selection via the Iasso”. J. of the Royal Statistical Society : Series B 58(1), 267-288, 1996
[32] The FACTOR Procedure. SAS/STAT® 9.2 User's Guide Second Edition, Chapter 33, pp. 1545-1633. The SAS Institute. http://support.sas.com/documentation/cdl/en/statug/63347/HTML/default/viewer.htm#fac tor_toc.htm
[33] Kaiser, H. F. (1958). The Varimax criterion for analytic rotation in factor analysis. Psychometrika, 1958, 23(3), 187-200.
[34] Gorsuch, R. L. (1983). Factor Analysis, 2nd edition. Lawrence Erlbaum. http://books.google.com/books?id=GkvbHohpefMC&printsec=frontcover&dq=gorsuch&hl=en&ei=R9vLTbLuLo-ChQffo-SoAg&sa=X&oi=book_result&ct=result&resnum=5&ved=0CEcQ6AEwBA#v=onepage&q &f=false
[35] Goldberg, L. R., Johnson, J. A., Eber, H. W., Hogan, R., Ashton, M. C., Cloninger, C. R., & Gough, H. C. (2006). The International Personality Item Pool and the future of public-domain personality measures. Journal of Research in Personality, 40, 84-96.
[36] Wellman, Barry and S. D. Berkowitz (eds.) 1988. Social structures: A network approach Cambridge: Cambridge University Press. http://books.google.com/books?id=XIw4AAAAIAAJ&printsec=frontcover&dq=wellman+berko witz&hl=en&ei=0NvLTc-OM9OBhQf0puioAg&sa=X&oi=book_result&ct=result&resnum=1&ved=0CDAQ6AEwAA#v=onepage&q&f=false
[37] Arteaga, Sonia M., Mo Kudeki and Adrienne Woodworth (2009). Combating Obesity Trends in Teenagers through Persuasive Mobile Technology. SIGACCESS Newsletter, issue 94, June 2009.

1. A method for predicting user cognitive and personality profiles, comprising automatically computing values of cognitive and personality indicators of users of a telecom operator system by means of machine learning and data mining algorithms from at least behavioral information available in a telecom operator system without analyzing any content of the actual communication between the users, to obtain a multi-dimensional Cognitive and Personality vector for each of the users.

2. A method as per claim 1, wherein said information available in a telecom operator system is extracted from the operator's records comprising at least one of Social Network Analysis metrics, Call Detailed Record information and commercial information of said users stored in an operator's Data Warehouse and Customer Relationship Management systems.

3. A method as per claim 2, further comprising using information from previous surveys, or questionnaires, answered by a representative sample of users as an input of said machine learning and said data mining algorithms.

4. A method as per claim 3, comprising building one or more complex computer models that infer values of psychological dimensions of users by means of said machine learning and said data mining algorithms.

5. A method as per claim 4, comprising once said complex computer models have been learned using a sample of users, applying said complex computer models to all users of a telecommunications company in the same region to infer their personality profile.

6. A method as per claim 4, wherein said complex computer model is implemented and run to obtain said multi-dimensional Cognitive and Personality vector.

7. A method as per claim 6, comprising performing said machine learning algorithms, a feature selection process in order to at least select those variables of said information available in said telecom operator system having a highest correlation to a target variable.

8. A method as per claim 7, further comprising eliminating those variables of said information available in said telecom operator system with lowest impact according to a recursive feature elimination process.

9. A method as per claim 7, wherein said selected variables are used in a standard regression algorithm in order to model some target psychometric variables.
